(19) United States
(12) Patent Application Publication
(10) Pub. No.: US 2012/0065558 A1
(43) Pub. Date: Mar. 15, 2012

(54) Lower Back Alignment And Decompression Machine

(76) Inventor: Marshall West Abercrombie, III, Atlanta, GA (US)

(21) Appl. No.: 12/878,053

(22) Filed: Sep. 9, 2010

(51) Int. Cl. A61H 15/00

(52) U.S. Cl. 601/115

(57) ABSTRACT

A lower back alignment and decompression exercise machine having: an elongated base member, a padded seat having a front end and a rear end and at least one spring loaded pedestal having an adjustable length is located between and connected to the elongated base member and the padded seat. A roller having a semi rigid surface and a length of between four and ten inches is located behind the rear end of the seat where the bottom of the roller is substantially level with the top of the seat.

### BACKGROUND OF THE INVENTION

1. Field of the Invention

The present invention relates to a lower back alignment and decompression machine.

2. Description of Related Art

Exercise machines for relieving back pain is known in the prior art. More specifically, by way of example, U.S. PreGrant Publication No. 2006/0,142,683 to Johnson; et al. discloses parameters of a treatment profile which include a high tension level, a low tension level, a high tension time period, and a low tension time period. Each of the cycles includes an application of a tensile force at a high tension level for a high tension time period and an application of the tensile force at a low tension level for a low tension time period.

U.S. Pat. No. 7,361,128 to Chen discloses an exercising machine having a front frame, a rear frame and a seat assembly where, when a user is in an inverted position, the user's body is stretched and pressure on the spine can be eliminated.

U.S. Pat. No. 7,303,517 to Pandozy discloses an inversion apparatus for performing exercises of suspending the body of a person in an inverted position which includes a stable steel frame, a winch, and a pair of padded anchor rings which connect the feet of the person to a winch operated by a motor or manually. The person may perform multiple exercises in the inverted position.

U.S. Pat. No. 7,125,389 to Sin discloses a spinal massager capable of performing oscillating or chiropractic operation along the vertebrae of a user who lies on the massager with the feet elevated above the head.

U.S. Pat. No. 7,052,448 to Teeter discloses a tilting inversion exerciser having a stand, a table rotatably attached to the stand to support a user, and a carrier slidably received in the table. The carrier includes a massage device for massaging the user.

U.S. Pat. No. 6,960,174 to Fenkel discloses a machine which alternately applies compression and traction to a patient. A frame includes: a platform having an upper body support pad with controllable resistance to forward and backward displacement, rollers supporting the lower back, buttocks and thighs; and a motor-driven foot support which moves forward and backward.

U.S. Pat. No. 6,319,213 to Tomac discloses body support platform that has a foot end and a head end and including a base section and a back support section which is movable relative to the base section along a longitudinal axis that extends between the foot end and the head end of the body support platform and is connected with a vibrator.

U.S. Pat. No. 5,718,660 to Chen discloses a base supported in an inclined angle where the user's feet are pulled to straighten the spinal column.

U.S. Pat. No. 4,372,552 to Carlmark discloses a hang stand for persons with injuries to their backs having an upper bar which is located at a height that when a person grasps the bar with both hands, the person can hang freely.

### SUMMARY OF THE INVENTION

In an exemplary embodiment of the present invention, there is disclosed a lower back alignment and decompression exercise machine having: an elongated base member, a padded seat having a front end and a rear end and at least one spring loaded pedestal having an adjustable length is located between and connected to the elongated base member and the padded seat. A roller having a semi rigid surface and a length of between four and ten inches is located behind the rear end of the seat where the bottom of the roller is substantially level with the top of the seat.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of an exercise machine for decompressing and aligning a person's lower back in accordance with the principles of the invention; and

FIG. 2 is a top view of the exercise machine of FIG. 1.

### DESCRIPTION OF THE PREFERRED EMBODIMENT

The exercise machine here disclosed is for use by people who suffer daily from lower back pain. Some conditions which can be treated include, but is not limited to, bulging or herniated disc, lumbar strains, sciatica degenerative discs, spinal arthritis, post-surgical low back pain, and acute back pain.

Although there are many machines available that offer unique ways in which to decompress the back, the exercise machine which is here disclosed is a machine that allows one cushioned roller to specifically address the lower lumbar area of the back. More specifically, the person simply sits on a seat that is about twenty inches off the floor and leans back into a roller which can be adjusted to press against the L4/L5 area of the lower back. As the person leans back, the negative pressure of the roller will cause a misaligned disc to be sucked back into place and create more space between the vertebrae so that more blood and oxygen can get into the area. The lower back can be decompressed and aligned with the exercise machine here disclosed as the abdominal muscles are in use as the “lean back” movement is made. The abdominal muscles act as a hinge allowing a relaxed back which means no back muscles pulling against the lean back movement. Instead of a “feel good” exercise machine, this machine aligns and decompresses and improves a persons posture and corrects muscle imbalance. Muscle imbalance is without question a major cause of back pain for many back sufferers and this machine also addresses this area.

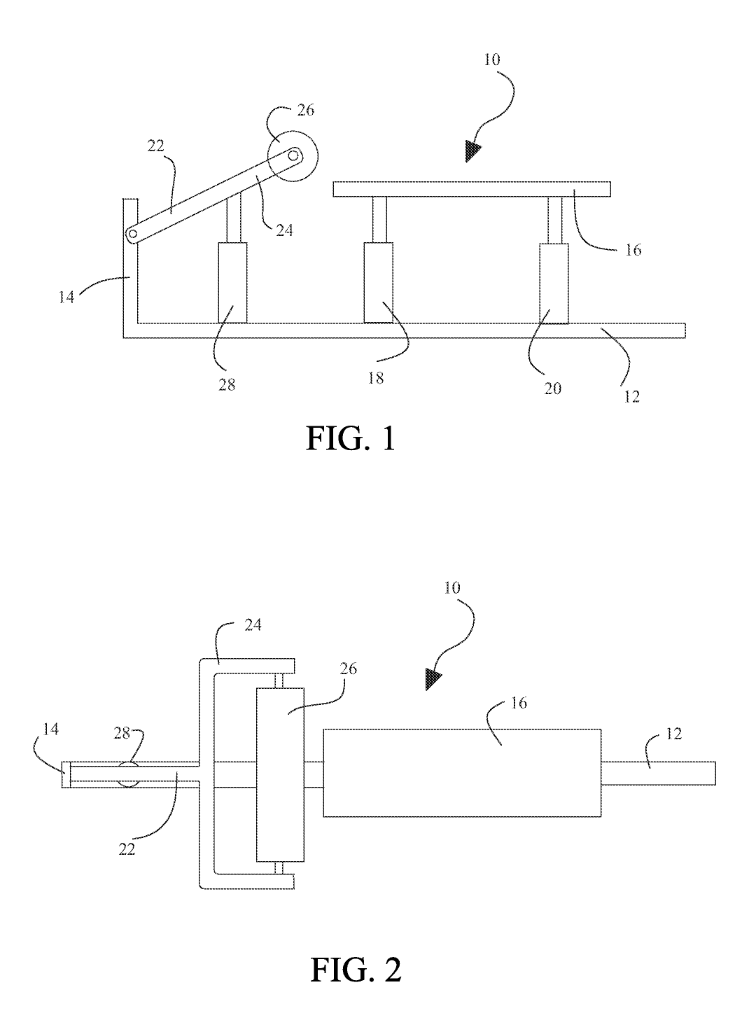

Referring to FIGS. 1 and 2, there is shown a side view and a top view of an exercise machine for decompressing and aligning a person's lower back in accordance with the principles of the invention. The lower back alignment and decompression exercise machine 10 has a long base member 12 which is located on the floor and is connected at one end to a short vertical member 14. The base member 12 and the vertical member 14 can be made of rectangular shaped tubing of aluminum having a thickness of about one and one half inches and a width of about six inches, where the length of the base member can be about three feet and the length of the vertical member can be about eighteen inches.

A padded seat 16 having a length of about twenty four inches and a width of about eighteen inches is attached to two adjustable spring loaded support pedestals 18, 20. The overall height of each pedestal is adjustable to locate the height of the seat to between eighteen inches and twenty six inches where a preferred height of the seat is twenty inches, more or less. In addition, each pedestal has a spring which can be preloaded to require a force of between fifteen and thirty five pounds before it begins to compress where a preferred force is between twenty and thirty pounds.

Pivotally connected to the short vertical member 14 is a support member 22 which is connected to a U shaped member 24 having two arms which are connected to an axel of a roller 26. Roller 26 can have a diameter of between four and ten inches where a preferred diameter is about six inches more or less and a length of between four and fourteen inches. The surface of the roller can be a semi rigid or compressible material of rubber, a plastic, foam plastic, etc. Located between the pivotal support member 22 and the long base member 12 is an adjustable pedestal 28 which may be spring loaded. The roller 26 is located slightly away from the rear edge of the seat and the pedestal 28 is adjusted to position the bottom of roller 26 to be substantially level with the top of the seat 16. Pedestal 28, which may be spring loaded to require a force of between ten and fifty pounds before it begins to compress where a preferred force of about thirty pounds is preferred.

In use, a user initially sits erect on the padded seat with both feet flat on the floor with the roller positioned at the very base of the back. The initial position of sitting with the roller at the base of the back is primarily a corrective posture position. Next, the user simply leans back further with his/her buttocks sliding forward on the seat where most of the user's weight is now being shifted to the roller. As the user leans back, the seat will tilt slightly to provide some support to the user's buttocks. As the user leans back the roller moves from the lower back upwards toward the middle of the back thus decompressing and aligning the lower back. It is suggested that this procedure be repeated five to ten times. However, the number of times the procedure is repeated is up to the discretion of the user before relief occurs.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A lower back alignment and decompression exercise machine comprising:
an elongated base member;
a padded seat having a front end and a rear end;
at least one spring loaded pedestal located between and connected to the elongated base member and the padded seat; and
a roller located behind the rear end of the seat;
wherein the bottom of the roller is substantially level with the top of the seat.

2. The exercise machine of claim 1 wherein the height of the seat can be adjusted by changing the length of the pedestal.

3. The exercise machine of claim 2 wherein the force of the spring of the spring loaded pedestal is adjustable.

4. The exercise machine of claim 3 wherein the surface of the roller is semi rigid.

5. The exercise machine of claim 3 wherein the surface of the roller is rubber, a plastic or foam plastic.

6. The exercise machine of claim 3 wherein the roller has a diameter of between four and ten inches.

7. The exercise machine of claim 3 wherein the roller has a length of between four and fourteen inches.

8. The exercise machine of claim 7 wherein the roller is connected to a U shaped member and a support member which is pivotally coupled to a vertical member attached to the elongated base member.

9. The exercise machine of claim 7 wherein a spring loaded pedestal which preloads the roller is connected between the support member and the elongated base member.

10. The exercise machine of claim 9 wherein the spring loaded pedestal is preloaded to between ten and fifty pounds.

11. The exercise machine of claim 8 wherein the base member and the vertical member are made of aluminum.

12. The exercise machine of claim 3 wherein the spring loaded pedestal is preloaded to between fifteen and thirty five pounds.

13. The exercise machine of claim 2 wherein the length of the pedestal can be varied between eighteen and twenty six inches.

14. The exercise machine of claim 13 wherein the length of the pedestal is twenty inches.
